(19) United States
(12) Patent Application Publication
(10) Pub. No.: US 2023/0281050 A1
(43) Pub. Date: Sep. 7, 2023

(54) ADAPTIVE THROTTLING WITH TENANT-BASED CONCURRENT RATE LIMITS FOR A MULTI-TENANT SYSTEM

(71) Applicant: Oracle International Corporation, Redwood Shores, CA (US)

(72) Inventors: Anuj Kaushal, Noida (IN); Sumit Aneja, Noida (IN); Antony James Reynolds, Colorado Springs, CO (US)

(73) Assignee: Oracle International Corporation, Redwood Shores, CA (US)

(21) Appl. No.: 17/688,154

(22) Filed: Mar. 7, 2022

(51) Int. Cl. G06F 9/50; G06F 11/34

(52) U.S. Cl. CPC G06F 9/5038; G06F 9/505; G06F 9/5077; G06F 11/3433

(57) ABSTRACT

The present embodiments relate to adaptive throttling with tenant-based concurrent rate limits. A first exemplary embodiment provides a method for adaptive throttling with tenant-based concurrent rate limits. The method can include a computing device receiving a request directed to a first tenant of a multi-tenant cloud infrastructure system. The first tenant being granted access to a limited processing capacity to process a limited number of requests. The computing device can further determine whether the multi-tenant cloud infrastructure system is in stress. The computing device can further permit the first tenant access to the additional processing capacity to process a number of requests greater than the limited number of requests.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others.

The computing resources of a cloud environment are finite and can get stretched if the environment attempts to fulfill too many requests. A CSP can manage its resources by specifying a predefined rate limit on the number of concurrent requests from a tenant that can be serviced by the cloud environment.

### BRIEF SUMMARY

The present embodiments relate to adaptive throttling with tenant-based concurrent rate limits. A first exemplary embodiment provides a method for adaptive throttling with tenant-based concurrent rate limits. The method can include a computing device receiving a request directed to a first tenant of a multi-tenant cloud infrastructure system. The first tenant being granted access to a limited processing capacity to process a limited number of requests concurrently.

The method can further include the computing device determining whether to throttle the request or permit the request and grant the first tenant access to additional processing capacity to concurrently process the request. The determination can comprise the following: determining a total number of requests to the first tenant and a second tenant in the multi-tenant cloud infrastructure system, the total number of requests to the first tenant and the second tenant in the multi-tenant cloud infrastructure system including the received request to the first tenant; determining a stress limit of the multi-tenant cloud infrastructure system by applying a stress factor value to a maximum number of requests the multi-tenant cloud infrastructure system is capable of concurrently processing; and comparing the total number of requests to the first tenant and a second tenant in the multi-tenant cloud infrastructure system and the stress limit.

The method can further include the computing device permitting the first tenant access to the additional processing capacity to concurrently process a number of requests greater than the limited number of requests.

A second exemplary embodiment relates to a computing system. The computing system can include a processor. The computing system can further include a computer-readable medium including instructions that, when executed by the processor, cause the processor to receive a request directed to a first tenant of a multi-tenant cloud infrastructure system. The first tenant being granted access to a limited processing capacity to process a limited number of requests.

The instructions can further cause the processor to determine whether to throttle the request or permit the request and grant the first tenant access to additional processing capacity to concurrently process the request. The determination can comprise the following: determining a total number of requests to the first tenant and a second tenant in the multi-tenant cloud infrastructure system, the total number of requests to the first tenant and the second tenant in the multi-tenant cloud infrastructure system including the received request to the first tenant; determining a stress limit of the multi-tenant cloud infrastructure system by to a stress factor value to a maximum number of requests the multi-tenant cloud infrastructure system is capable of processing concurrently; and comparing the total number of requests to the first tenant and a second tenant in the multi-tenant cloud infrastructure system and the stress limit.

The instructions can further cause the processor to permit the first tenant access to the additional processing capacity to concurrently process a number of requests greater than the limited number of requests.

A third exemplary embodiment relates to a non-transitory computer-readable medium. The non-transitory computer-readable medium can include stored thereon a sequence of instructions, which, when executed by a processor, cause the processor to execute a process. The process can include receiving a request directed to a first tenant of a multi-tenant cloud infrastructure system. The first tenant being granted access to a limited processing capacity to process a limited number of requests.

The process can further include determining whether to throttle the request or permit the request and grant the first tenant access to additional processing capacity to concurrently process the request. The determination can comprise the following: determining a total number of requests to the first tenant and a second tenant in the multi-tenant cloud infrastructure system, the total number of requests to the first tenant and the second tenant in the multi-tenant cloud infrastructure system including the received request to the first tenant; determining a stress limit of the multi-tenant cloud infrastructure system by to a stress factor value to a maximum number of requests the multi-tenant cloud infrastructure system is capable of processing concurrently, the stress factor value being between zero and one; and comparing the total number of requests to the first tenant and a second tenant in the multi-tenant cloud infrastructure system and the stress limit.

The process can further include permitting the first tenant access to the additional processing capacity to concurrently process a number of requests greater than the limited number of requests.

### BRIEF DESCRIPTION OF THE DRAWINGS

FIG. 1 is a block diagram of an exemplary network environment, according to at least one embodiment.

FIG. 2 is a block diagram of an exemplary adaptive throttling service in a cloud infrastructure system, according to at least one embodiment.

FIG. 3 is a block diagram of a request phase to determine whether to accept or reject a request, according to at least one embodiment.

FIG. 4 is a graph illustrating an adaptive throttling process according to at least one embodiment.

FIG. 5 is a signaling diagram illustrating an exemplary method for adaptive throttling with tenant-based concurrent rates according to at least one embodiment.

FIG. 6 is a block diagram illustrating an exemplary request phase flow chart for determining whether to accept or reject a request, according to at least one embodiment.

FIG. 7 is a block diagram illustrating an exemplary request phase flow chart for determining whether to accept or reject a request, according to at least one embodiment.

FIG. 8 is a block diagram illustrating an exemplary response phase flow chart, according to at least one embodiment.

FIG. 9 is a block diagram illustrating a pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, various examples will be described. For the purposes of explanation, specific configurations and details are set forth to provide a thorough understanding of the examples. However, it will also be apparent to one skilled in the art that the examples may be practiced without the specific details. Furthermore, well-known features may be omitted or simplified in order not to obscure the example being described.

Cloud Service Providers (CSPs) have limited resources to provide to the tenants of the cloud computing environment. As requests come in from end users, the tenant has to perform work to satisfy the request. Each request requires some number of resources in the form of processing capacity from the cloud computing environment. The CSPs implement defensive techniques to protect their underlying services and resources from becoming stretched too thin and unavailable to one or more tenants. Concurrent rate limiting can be one such defensive technique used to limit the number of tenant requests that can be processed concurrently in a cloud computing system. In many instances, a CSP can allot each tenant a fixed request quota (i.e., fixed limits) that the tenant is permitted to process. A tenant can process a request from an end user as long as the tenant has not breached their fixed request quota. In this sense, a particular tenant cannot consume more resources than their fixed request quota, thereby preventing an impact on the other tenants of the same cloud computing system. However, this fixed-quota approach often leads to under-utilization of the cloud computing system's resources and can also lead to poor computing performance for both the tenant and the CSP.

Embodiments as described herein provide an adaptive throttling service that can manage the allocation of a cloud computing system's resources. In particular, the adaptive throttling service can manage the ingress of a request to a tenant from a public endpoint to a cloud computing system via the interne and the egress of a response from the cloud computing system back to the public endpoint. The adaptive throttling service can receive an authenticated request directed towards a tenant and determine whether the request succeeds or fails based on adaptive global- and tenant-based concurrent rate limits. The herein described concurrent rate limits are soft limits that can be breached in instances that the cloud computing system is not in stress. Based on whether the authenticated request succeeds or fails to ingress the cloud computing system, the tenant can either receive resources to process the request or be throttled and denied the resources to process the request. The soft limits advantageously permit a CSP to offer additional resources to a tenant in periods that the cloud computing system's resources are underutilized.

The adaptive throttling service can manage two token buckets to assist in managing the ingress and egress of incoming requests and responses. The first bucket can be a global bucket that tracks available tokens at the system level. Each token can be equivalent to a unit of processing capacity used to perform work to process a request. The number of tokens in the global bucket can be based on a stress limit SL. The stress limit, SL, can be calculated based on a CSP defined stress factor value, SF, and the maximum number of concurrent requests, M, that the cloud computing system can process. For example, if the stress factor value, SF, is 0.5, and the maximum number of requests, M, that the cloud computing system can process is ten, the global bucket can include a maximum of five tokens (e.g., (SF*M)=(0.5*10)=5=SL). In other words, the number of tokens in the global bucket is associated with the number of concurrent requests that the cloud computing system can process without breaching the stress limit. Tenants are permitted to withdraw tokens from the global bucket to access resources to process requests. The tokens in the global bucket are refilled as tenants complete processing requests. As the number of concurrent requests in the multi-tenant cloud computing system changes as incoming requests are received and requests are processed, the number of tokens in the global bucket dynamically changes to reflect these changes. The second bucket can be a tenant bucket that tracks allotted tokens at a tenant level. The maximum number of tokens in the tenant bucket can be based on the limited number of concurrent requests that the tenant is permitted to process. For example, the CSP can assign a tenant request quota of three concurrent requests. Therefore, the tenant bucket can include a maximum of three tokens. Each tenant of the multi-tenant cloud computing system can have their own allotted number of tenant tokens independent of the number of tokens another tenant is allotted.

In response to receiving an authenticated request, the adaptive throttling service can determine whether the cloud computing system is under stress based on the above-referenced stress factor value, SF. The adaptive throttling service can determine the number of outstanding concurrent requests, C, for all tenants in the cloud computing system. Outstanding concurrent requests can be any requests that have been allowed by the adaptive throttling service, but not yet finished processing. The adaptive throttling service can detect the maximum number of concurrent requests, M, that the cloud computing system can process before becoming stressed. The maximum number of concurrent requests, M, can, in some embodiments, be designated by the CSP. The stress limit, SL, can be calculated by applying the stress factor value, SF, by the maximum number of concurrent requests, M, that the cloud computing system can process (e.g., SL=SF*M). If the number of outstanding concurrent requests, C, is less than the stress limit, the adaptative throttling service can withdraw a token from the global bucket. The tenant can use the token to access the processing capacity associated with the token and process the authenticated request.

If, however, the number of outstanding concurrent requests, C, is greater than the stress limit, the cloud computing system is in stress. Furthermore, as the number of tokens in the global bucket can be associated with the stress limit, the global bucket can be empty. The adaptive throttling service can determine whether, with the addition of the authenticated request, the number of concurrent requests being processed by the tenant is greater than the limited number of concurrent requests that the tenant is permitted to take. If the number of concurrent requests, including the authenticated request, is greater than the number of permitted requests, the adaptive throttling service can issue an error such as an HTTP 429 Too Many Requests error. If the number of concurrent requests, including the authenticated request, is less than or equal to the limited number of permitted requests, the adaptive throttling service can withdraw a token from the tenant bucket. The tenant can use the token to access the processing capacity associated with the token and process the authenticated request.

Consider an example in which a cloud computing system tenant runs a mobile application for learning a new language. The CSP can have designated a tenant request quota of five concurrent requests for the tenant. An end user can open the language learning application on their smartphone, and the application can send a request to the tenant to return a language learning lesson. The request can be routed directly into the data plane of the cloud computing system. The request can be authenticated by an API gateway executing in the data plane and sent to an adaptive throttling service. The adaptive throttling service can determine whether the authenticated request will succeed or fail. Upon receipt of the authenticated request, the adaptive throttling service can determine whether the cloud computing system is in stress. To do so, the adaptive throttling service can detect the number of overall outstanding concurrent requests including the authenticated request, C (e.g., fifty concurrent requests including the authenticated request). The adaptive throttling service can also detect the stress limit, SL, of the cloud computing system. In this example, the stress factor value, SF, is 0.55 and the maximum number of concurrent requests, M, that the cloud computing system can process is one hundred. Therefore, the stress limit SL is fifty-five requests (e.g., SL=(SF*M)'(0.55*100)=55). In this example, the number of overall outstanding concurrent requests including the authenticated request, C, is less than the stress limit, SL. Therefore, the adaptive throttling service can withdraw a token from the global bucket and the language learning tenant can process the request.

If, however, the stress factor value, SF, was 0.49, the cloud computing system would have been in stress. As the number of overall outstanding concurrent requests including the authenticated request, C, is greater than the stress limit, SL (i.e., 50>0.49*100), the cloud computing system is in stress. The adaptive throttling service can then turn to the tenant bucket. If the tenant has not exceeded their tenant request quota (e.g., the tenant is processing four or fewer concurrent requests), the adaptive throttling service can withdraw a token from the tenant bucket. If, however, the tenant is at their tenant request quota (i.e., the tenant is currently processing five concurrent requests and adding the authenticated request would result in six concurrent requests), the adaptive throttling service can throttle the request. A throttled request can result in the request being held in cache until the tenant can process the request, or an error message can be generated.

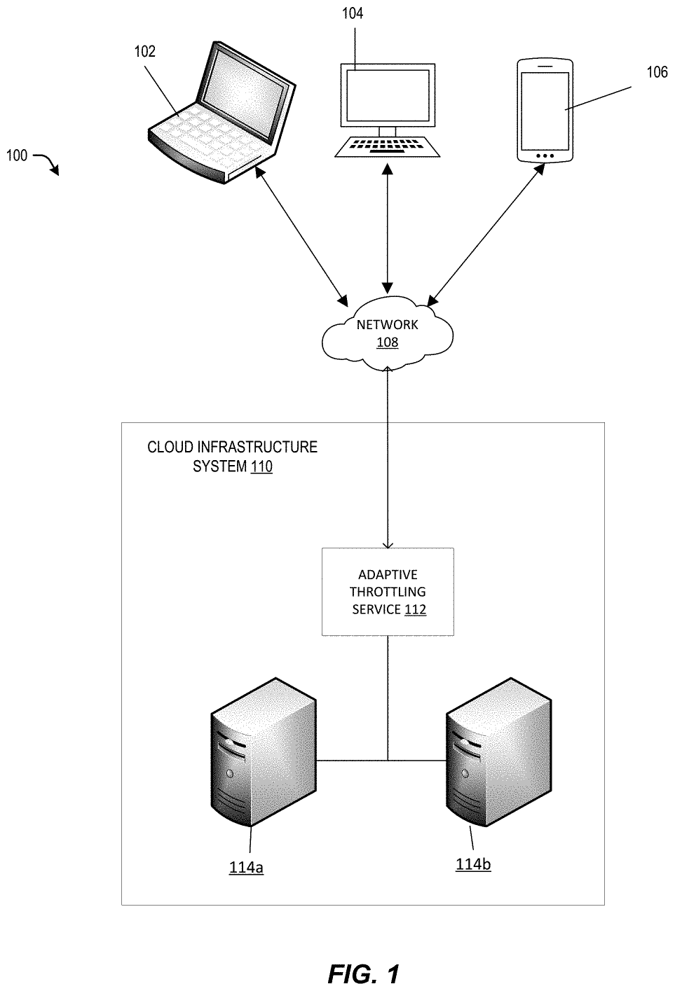

Referring to FIG. 1, a block diagram of an exemplary network environment 100 according to one or more embodiments is shown. The network environment 100 is operable to permit data communication between devices within the network environment 100 using one or more wired or wireless networks. The devices can include a first user device 102, a second user device 104, and a third user device 106 connected, via a network 108, to a cloud infrastructure (CI) system 110. The CI system 110 can be a multi-tenant CI system. An end user of each of the first user device 102, the second user device 104, and the third user device can use their device to transmit requests to each tenant of the CI system 110. It should be appreciated that an end user in some circumstances can be another computing device, for example, a system server requesting that another server configure a networking protocol. The CI system 110 can accommodate concurrent requests to multiple tenants from multiple computing devices.

In embodiments, the CI system 110 can manage the concurrent requests by implementing adaptive throttling techniques to manage the ingress and egress of requests in the CI system 110. The CSP can divide tenants into two or more hierarchical classes, in which one or more of the tenant classes can receive a greater proportion of services, applications, and resources than the other tenant classes. For the purposes of this application, the tenants of the CI system 110 can be divided into class one and class two tenants. Class one tenants can receive a greater proportion of services, applications, and resources than class two tenants. Class one tenants can further breach their respective tenant request quota in instances that the CI system 110 is not under stress and has the resources to handle the requests. Class two tenants cannot breach their tenant request quota.

The CI system 110 can include an adaptive throttling service 112 and one or more interconnected computing devices 114a, 114b implementing one or more cloud computing applications or services. The CI system 110 can include a combination of hardware such as bare metal servers and software such as application programming interfaces (APIs) for receiving messages from computing devices, calling of the CI system 110 for resources, and transmitting responses back to the computing devices. For example, the CI system 110 can include a collection of APIs for communicating with one or more end user computing devices. The computing devices 114a, 114b can include resources, such as processing capacity, services, hardware resources, and virtual resources.

The adaptive throttling service 112 can be software that is accessible by the data plane of the CI system 110. An API gateway associated with the data plane can determine whether a request is authenticated and permitted to use cloud infrastructure resources. The API gateway can then transmit an authenticated request to the adaptive throttling service 112. The adaptive throttling service 112 can manage access to resources allocated to each tenant of the CI system 110. The adaptive throttling service 112 can determine whether the CI system 110 is in stress. Based on whether the CI system 110 is in stress, the adaptive throttling service 112 can further allow a class one tenant access to additional processing capacity, even if the class one tenant is processing their allotted tenant request quota of concurrent requests. The adaptive throttling service 112 can further enforce a class two tenant's tenant request quota regardless of whether the CI system 110 is in stress. The adaptive throttling service 112 can throttle an authenticated request if the class two tenant is at their allotted tenant request quota. The resources can be associated with one or more computing devices 114a, 114b of the CI system 110. The computing devices 114a, 114b can be one or more servers in one or more data center environments (e.g., colocation centers).

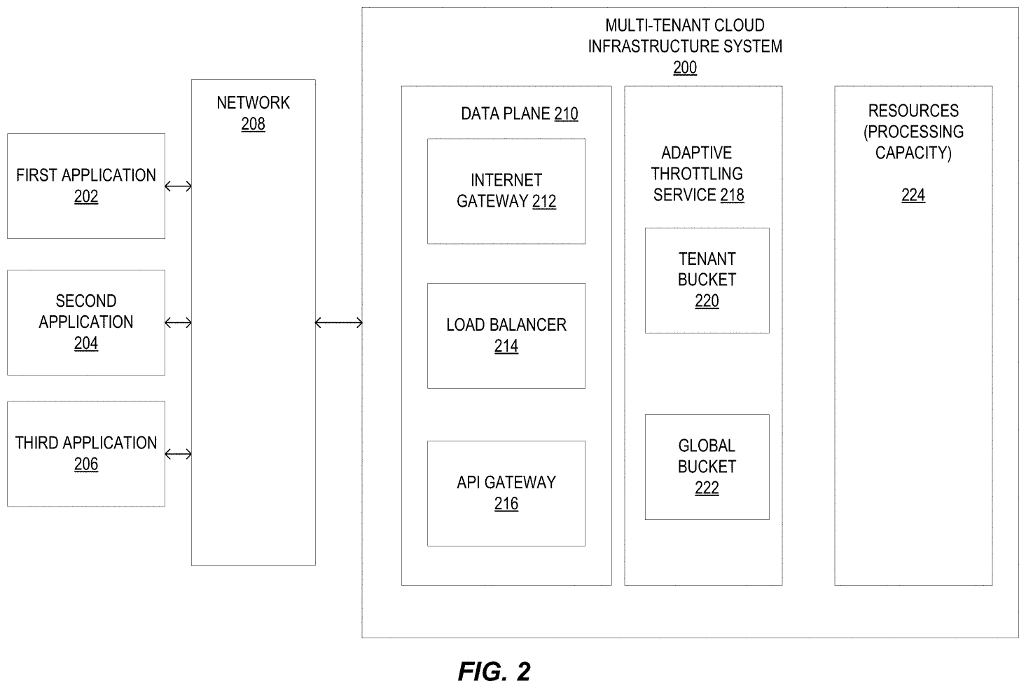

Referring to FIG. 2, a multi-tenant CI system 200 for adaptive throttling is shown in accordance with one or more embodiments. A first application 202, a second application 204, and a third application 206 can be implemented on a computing device and in operable communication with the multi-tenant CI system 200 via a network 208. Each of the first application 202, the second application 204, and the third application 206 can transmit a request to the multi-tenant CI system 200 via the network 208. Each request can be directed to a respective tenant of the multi-tenant CI system 200.

The multi-tenant CI system 200 can include a data plane 210, which can be software that carries and processes data requests. The data plane 210 can include an internet gateway 212, which can convert a request an application from one IP protocol to an IP protocol suitable for the multi-tenant CI system 200.

The data plane 210 of the multi-tenant CI system 200 can further include a load balancer 214 that can receive a request via the internet gateway 212 and can distribute the request across one or more servers of the multi-tenant CI system 200. It should be appreciated that a request received from an application is not necessarily an authenticated request. Therefore, the request received and outputted by the load balancer 214 can be an unauthenticated request.

The data plane 210 of the multi-tenant CI system 200 can further include an application programming interface (API) gateway 216. The API gateway 216 can receive a request from the load balancer 214 and authenticate the request. The API gateway 216 can support multiple authentication methods to satisfy the multiple applications in operable communication with multi-tenant CI system 200. The API gateway 216 can be configured to use one or more authentication methods to validate incoming requests prior to transmitting the request to a backend service such as the adaptive throttling service 218. In this sense, the adaptive throttling service 218 can only receive legitimate requests to tenants, and therefore the adaptive throttling service 218 is not evaluating illegitimate requests.

The multi-tenant CI system 200 can further include the adaptive throttling service 218. The adaptive throttling service 218 can manage the ingress and egress of authenticated requests and responses for the multi-tenant CI system 200. A CSP can assign each tenant of the multi-tenant CI system 200 a tenant request quota of the limited number of concurrent requests that can be processed by the tenant. Each tenant can be associated with a respective tenant bucket 220. Each tenant bucket can be software that maintains tokens assigned to the tenant. Each token can be associated with a unit of processing capacity used to perform the work for processing a request. If the tenant is authorized to process a request, the adaptive throttling service 218 can withdraw a token from the tenant bucket 220. The adaptive throttling service 218 can transmit the token to the tenant. The tenant can present the token to access the processing capacity of the multi-tenant CI system 200. When the tenant is finished using the processing capacity to process the request, the adaptive throttling service 218 can fill the tenant bucket with another token. The number of tokens in the tenant bucket 220 can be equal to the limited number of concurrent requests that the tenant is permitted to process.

The adaptive throttling service 218 service further includes a global bucket 222 that can hold tokens that are shared across all the tenants of the multi-tenant CI system 200. Each token can be associated with a unit of processing capacity used to perform the work for processing a request. The number of tokens in the global bucket 22 can be equivalent to the stress limit, SL, of the multi-tenant CI system 200. For example, if the CSP set a stress factor value at 0.8 and the maximum number of concurrent requests, M, that the cloud infrastructure system can process can be ten, the global bucket holds eight tokens (e.g., SL=0.8*10). If the stress limit, SL, is not an integer, the stress limit can be rounded up to the nearest integer. For example, if the stress limit, SL, is 7.4, the value can be rounded up to eight, and the global bucket 222 can hold eight tokens.

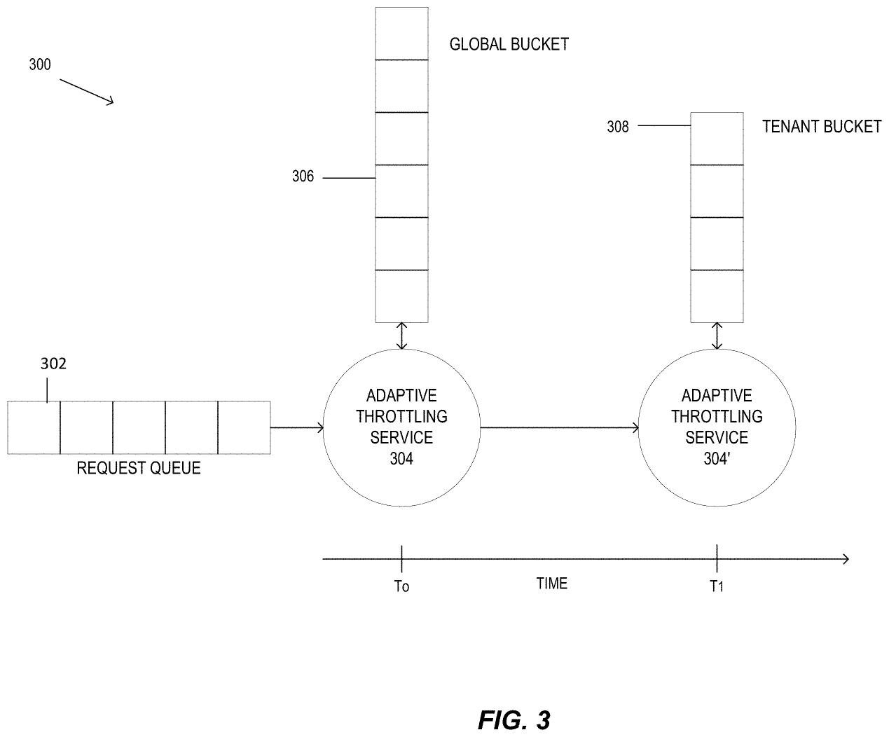

The adaptive throttling service 218 can manage the ingress and egress of requests to the multi-tenant CI system 200. Each request can require resources 224 of the multi-tenant CI system 200. The resources 224 can include processing capacity such as data, hardware devices, files, applications, services, and the like. The management of access to the resources is described with more particularity with respect to FIG. 3.

Referring to FIG. 3, a system 300 for managing ingress and egress of requests and responses is shown according to embodiments. The system 300 can include a request queue 302 that holds authenticated requests to each tenant of a CI system. As illustrated, each block in the request queue 302 includes an authenticated request from a user to a tenant. The request queue 302 can be managed by an adaptive throttling service 304, 304′ of the CI system. The system 300 can further include an adaptive throttling service 304, 304′ accessible by a data plane of the CI system. As illustrated, the adaptive throttling service 304, 304′ is shown at two different points in time (e.g., determining whether to withdraw a token from a global bucket 306 at a first time T₀, and determining whether to withdraw a token from a tenant bucket 308 at a second time T₁).

The adaptive throttling service 304 can retrieve a request from the request queue 302. In addition to the request to the tenant, each request can include a class of the tenant. In this example, the CI system can include class one tenants and class two tenants that are categorized in a hierarchical system. Class one tenants can be entitled to more resources than class two tenants. As described herein, the adaptive throttling service 304, 304′ can proceed differently based on whether the tenant is a class one tenant or a class two tenant.

If the tenant is a class one tenant, the adaptive throttling service 304 can proceed as follows. In response to retrieving an authenticated request from the request queue 302, the adaptive throttling service 304 can determine whether the CI system is in stress. The adaptive throttling service 304 can detect the number of outstanding concurrent requests, C, for all tenants in the CI system. The adaptive throttling service 304 can also detect the maximum number of concurrent requests, M, that the CI system can process. The adaptive throttling service 304 can further calculate the stress limit, SL, for the CI system. The adaptive throttling service 304 can apply the stress factor value, SF, by the maximum number of concurrent requests, M, that the cloud computing system can process (e.g., SL=SF*M). If the number of outstanding concurrent requests, C, is less than the stress limit, SL, the CI system is not in stress. Additionally, as the number of tokens in the global bucket 306 is associated with the number of concurrent requests that the system can handle without being in stress, a CI system that is not in stress can include tokens in the global bucket. The adaptative throttling service 304 can withdraw a token from the global bucket 306 and transmit the token to the tenant. The tenant can present the token to the CI system to access the processing capacity to process the authenticated request.

If, however, the number of outstanding concurrent requests, C, is greater than the stress limit, SL, (e.g., C>SL), the CI system is in stress. Furthermore, the global bucket 306, in this scenario, can be empty. The adaptative throttling service 304′ can then determine whether the tenant has breached its tenant request quota T₁. The adaptive throttling service 304′ can determine whether, with the addition of the authenticated request, the number concurrent requests being processed by the tenant is greater than the limited number of concurrent requests that the tenant is permitted to process.

The maximum number of tokens in the tenant bucket 308 is equal to the limited number of concurrent requests that the tenant is permitted to process. Therefore, the adaptive throttling service 304′ can determine whether the tenant bucket 308 has at least one token to satisfy the authenticated request. If there is not at least one token, the adaptive throttling service 304′ issues an error, such as an HTTP 429 Too Many Requests error. If there is at least one token in the tenant bucket 308, the adaptive throttling service 304′ withdraws the token from the tenant bucket 308. The tenant can use the resources associated with the withdrawn token to process the authenticated request. In this sense, the tenant can breach its tenant request quota even if the CI system is in stress.

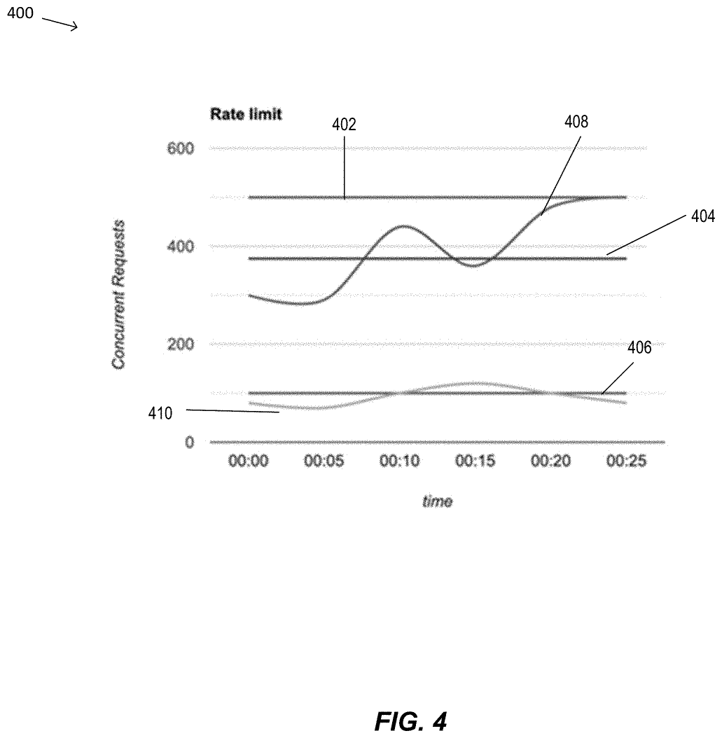

Referring to FIG. 4, a graph 400 describing the adaptive nature of the adaptive throttling service is shown. The graph 400 includes a number of concurrent requests on the y-axis and a time on the x-axis. The graph 400 includes a line 402 for the maximum number of requests, M, that a CI system can process at any given time. As illustrated, the line 402 is set at five hundred concurrent requests as the maximum number that the CI system can process. The graph 400 includes a stress limit 404 of the CI system. As illustrated, the stress limit 404 is set at three hundred and ninety requests. Therefore, a global bucket in this scenario can include a maximum of three hundred and ninety tokens. Therefore, if the CI system, at any point attempts to process between three hundred and ninety-one and five hundred concurrent requests at any time, the CI system is in stress. The graph includes a tenant request quota 406 for a class one tenant. As illustrated, the tenant request quota 406 is set at one hundred concurrent requests. Therefore, the tenant bucket in this scenario can include a maximum of one hundred tokens. The graph 400 further includes a line 408 for the total number of concurrent requests in the system. The graph 400 further includes a line 410 for the number of concurrent requests being processed by the class one tenant.

At time 00.05, the number of concurrent requests in the CI system is below the stress limit 404 based on the line 408. Additionally, the number of concurrent requests that the tenant is processing is below the tenant request quota 406 based on the line 410. At time 00.10 the number of concurrent requests in the CI system is greater than the stress limit 404, and the system is in stress. Therefore, if the adaptive throttling service receives an authenticated request directed to the tenant at time 00.10, the adaptive throttling service can determine that the CI system is in stress. Therefore, the adaptive throttling service can elect to not withdraw a token from the global bucket, as the global bucket is empty. The adaptive throttling service can then determine whether the tenant has any tokens in their tenant bucket. Based on the graph, it can be seen that the tenant is processing an equivalent number of tokens as the tenant request quota 406, and therefore the tenant bucket is empty. Therefore, the adaptive throttling service can elect to throttle the request at time 00.10.

At time 00.15, it can be seen in the graph 400 that the number of concurrent requests in the CI system are less than the stress limit 404 based on the line 408. Therefore, the adaptive throttling service can determine that the CI system is not in stress. Therefore, the adaptive throttling service can elect to withdraw a token from the global bucket. The tenant can then use the resources associated with the token and process the request. As seen in the graph, the tenant can process a greater number of concurrent requests than its tenant request quota 406 at time 00:15.

Therefore, as illustrated by the graph 400, the adaptive throttling service can allow a class one tenant to breach the soft global bucket limit and the tenant request quota 406. Additionally, in instances that the CI system is in stress and the tenant is at their tenant request quota 406, the adaptive throttling service can enforce the tenant request quota 406 on the class one tenant.

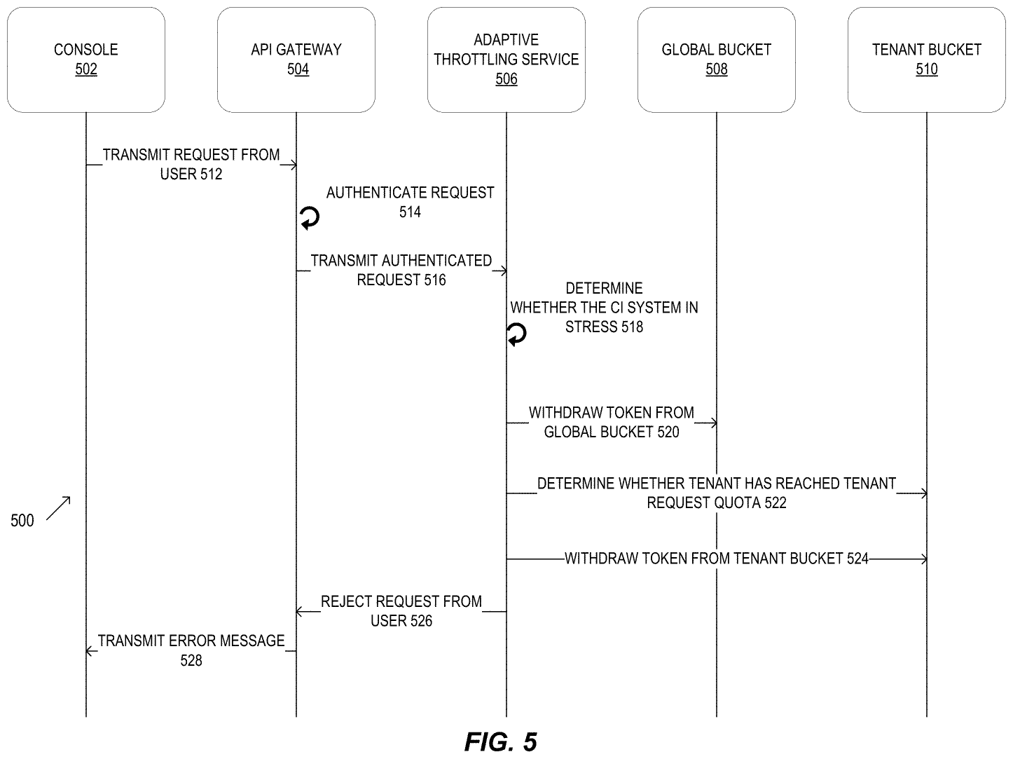

Referring to FIG. 5, a signaling process 500 illustrating an adaptive throttling process for a class one tenant according to one or more embodiments is shown. As shown in FIG. 5, a console 502, an API gateway 504, an adaptive throttling service 506, a global bucket 508, and a tenant bucket 510 can interact with each other. The operations of processes 500, 600, and 700 may be performed by any suitable computing device and may be used to perform one or more operations of these processes. Processes 500, 600, and 700 (described below) is illustrated as logical flow diagrams, each operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

At 512, the console 502 can transmit a request to a tenant of a multi-tenant CI system. The request can be, for example, a request to authenticate a password to access a service offered by the tenant. To authenticate the password, the request can be processed using CI system resources allotted to the tenant. The request can be received by an API gateway 504 implemented in a data plane of the CI system. In some embodiments, the request can be an unauthenticated request that is received by an internet gateway. The internet gateway can configure the IP protocol of the request to conform to the CI system. The internet gateway can transmit the unauthenticated request to a load balancer. The load balancer can transmit the unauthenticated request to the API gateway 504. The API gateway 504 can receive the unauthenticated request from the load balancer. At 514, the API gateway 504 can authenticate the request as being transmitted to a valid tenant of the CI system based on a set of credentials. The API gateway 504 can further determine a class of the tenant. At 516, the API gateway 504 can transmit the authenticated request and class to the adaptive throttling service 506.

At 518, the adaptive throttling service 506 can determine whether to allow or reject the request. The adaptive throttling service 506 can determine that the request is directed to a class one tenant. The adaptive throttling service 506 can determine whether the CI system is in stress. The adaptive throttling service 506 can detect the number of concurrent requests in the CI system. The adaptive throttling service 506 can then compare the number of concurrent requests in the CI system and the stress limit. If the number of concurrent requests in the CI system is below the stress limit, the adaptive throttling service 506 can determine that the CI system is not in stress. At 520, the adaptive throttling service 506 can withdraw a token from the global bucket 508. The adaptive throttling service 506 can further increment the total number of concurrent requests in the CI system by one. The adaptive throttling service 506 can further increment the number of concurrent requests being processed by the tenant by one. The adaptive throttling service 506 can then transmit the token to the tenant. The tenant can then use the resources associated with the token to process the request.

If, however, the number of concurrent requests in the CI system is above the stress limit, the adaptive throttling service 506 can determine that the CI system is in stress. In this instance, the adaptive throttling service 506 can determine whether the class one tenant has reached their tenant request quota at 522. The adaptive throttling service 506 can determine if there are any tokens in the tenant bucket 510. If there is at least one token in the tenant bucket 510, the adaptive throttling service 506 can withdraw the token from the tenant bucket 510 at 524. The adaptive throttling service 506 can further increment the total number of concurrent requests in the CI system by one. The adaptive throttling service 506 can further increment the number of concurrent requests being processed by the tenant by one. The adaptive throttling service 506 can then transmit the token to the tenant. The tenant can then use the resources associated with the token to process the request.

If, however, there are no tokens in the tenant bucket 510, the adaptive throttling service 506 can reject the authenticated request at 526 and transmit the rejection to the API gateway 504. At 528, the API gateway 504 can transmit an error message back to the console 502.

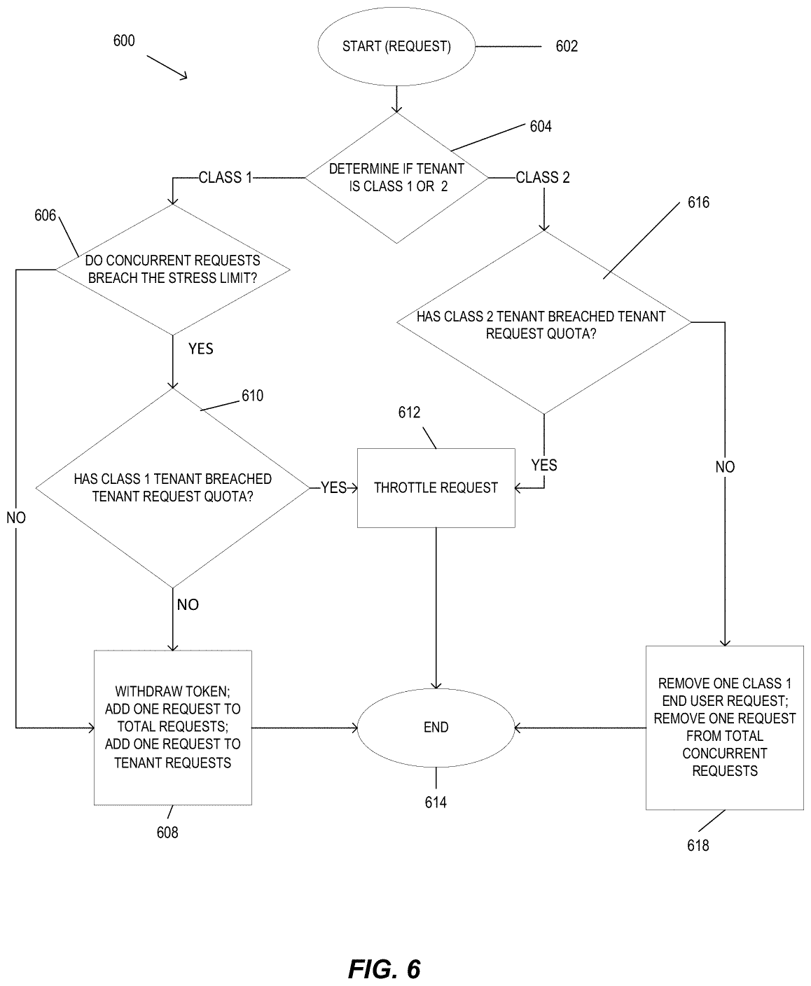

Referring to FIG. 6, an exemplary request phase flow chart 600 for determining whether to accept or reject a request according to an embodiment is shown. At 602, a user can use a console to transmit a request to a computing device of a multi-tenant CI system. The multi-tenant system can be a hierarchical system where one class has access to more applications, services, and resources than another class. For the purposes of this application, the multi-tenant system has two classes of tenants, class one and class two. Under this example, hierarchical system, a class one tenant is entitled to more applications, services, and resources than the class two tenant.

At 604, the computing device can determine whether the tenant is a class one tenant or a class two tenant. For example, the request can include a tenant identifier that the computing device uses to determine the tenant's class. If the tenant is a class one tenant, the computing device can proceed as follows. At 606, the computing device can determine whether the CI system is in stress based on the number of concurrent requests in the CI system and a stress limit. The computing device can determine the number of concurrent requests in the CI system. The computing device can then compare the number of concurrent requests in the CI system and the stress limit. If the number of concurrent requests in the CI system is below the stress limit, the computing device can determine that the CI system is not in stress. If, however, the number of concurrent requests in the CI system is below the stress limit, the computing device can determine that the CI system is in stress.

At 608, if the number of concurrent requests in the CI system is below the stress limit, the computing device can withdraw a token, such as from a global bucket. The computing device can further increment the total number of concurrent requests in the CI system by one. The computing device can further increment the number of concurrent requests being processed by the class one tenant by one. The class one tenant can then use the resources associated with the token to process the request.

If, however, the number of concurrent requests in the CI system is above the stress limit, the computing device can determine whether the class one tenant has breached their tenant request quota at 610. The computing device can communicate with the class one tenant's tenant bucket and retrieve data indicating whether the class one tenant's tenant bucket has at least one token. If the class one tenant's tenant bucket does not have at least one token, the computing device can throttle the request at 612.

If the class one tenant's tenant bucket has at least one token, the computing device can withdraw a token from the tenant bucket at 608. The computing device can further increment the total number of concurrent requests in the CI system by one. The computing device can further increment the number of concurrent requests being processed by the class one tenant by one. The tenant can then use the resources associated with the token to process the request. The class one tenant can use the resources associated with the token to process the request. Regardless of whether the computing device allows or throttles the request, the process can end at 614.

If at 604, the computing device can determine that the tenant is a class two tenant, the process proceeds to 616. At 616, the computing device can determine whether the class two tenant has breached their tenant request quota. The computing device can communicate with the class two tenant's tenant bucket and retrieve data indicating whether the class two tenant's tenant bucket has at least one token. The class two tenant can have a different tenant bucket than the class one tenant. If the class tow tenant's tenant bucket does not have at least one token, the computing device can throttle the request at 612.

If the class two tenant's tenant bucket has at least one token, the computing device can withdraw a token from the class two tenant's tenant bucket at 618. The computing device can further increment the total number of concurrent requests in the CI system by one. The computing device can further increment the number of concurrent requests being processed by the class two tenant by one. The class two tenant can then use the resources associated with the token to process the request. The class two tenant can use the resources associated with the token to process the request. Regardless of whether the computing device satisfies or rejects the request, the process can end at 614.

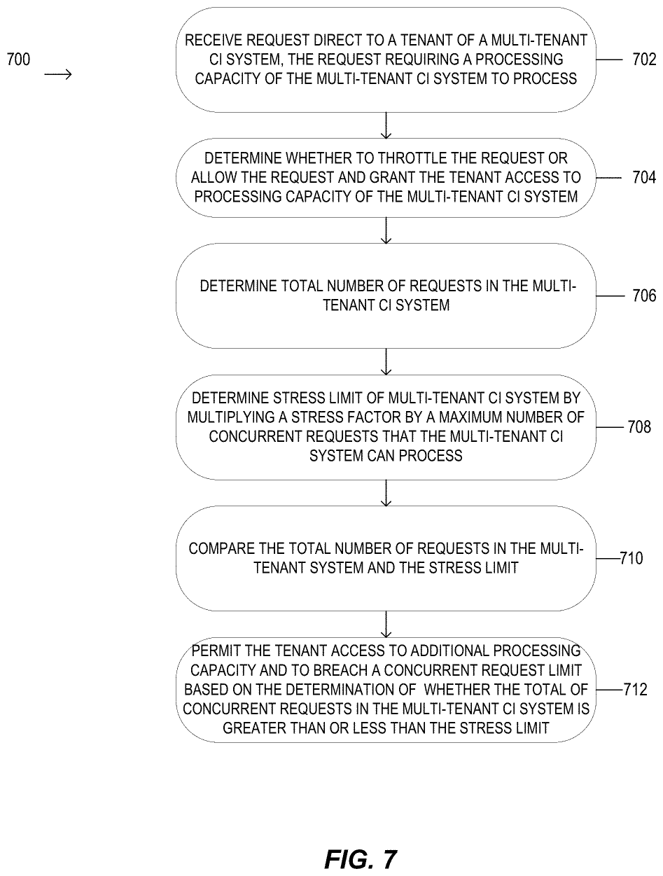

Referring to FIG. 7, an exemplary request phase flow chart 700 for determining whether to allow or throttle a request according to an embodiment is shown. At 702, a computing device of a multi-tenant cloud infrastructure system can receive a request directed to a first tenant of the multi-tenant cloud infrastructure system. The request can be transmitted by a console under the direction of a user. The multi-tenant cloud infrastructure system can be a hierarchical system where the first tenant is granted access to a limited processing capacity to process a limited number of requests. In order to process the requests, the first tenant may require a processing capacity of the multi-tenant cloud infrastructure system.

At 704, the computing device can determine whether to throttle the request, or permit the request and grant the first tenant access to additional processing capacity to process the request. The determination can be based on whether or not the multi-tenant cloud infrastructure system. In instances that the multi-tenant cloud infrastructure system is not in stress, the computing device can allow the first tenant to exceed the limited number of requests it is permitted to process concurrently.

At 706, the computing device can determine a total number of requests to the first tenant and a second tenant in the multi-tenant cloud infrastructure system. The total number of requests to the first tenant and a second tenant in the multi-tenant cloud infrastructure system includes the received request to the first tenant. At 708, the computing device can determine a stress limit of the multi-tenant cloud infrastructure system by applying a stress factor value to a maximum number of requests the multi-tenant cloud infrastructure system is capable of processing concurrently. The stress factor value being between zero and one. The factor value can be determined by a CSP based on historical performance data of the multi-tenant cloud infrastructure system.

At 710, the computing device can compare the total number of requests to the first tenant and a second tenant in the multi-tenant cloud infrastructure system and the stress limit. If the total number of requests to the first tenant and a second tenant in the multi-tenant cloud infrastructure system is less than the stress limit, the multi-tenant cloud infrastructure system is not in stress. If, however, the total number of requests to the first tenant and a second tenant in the multi-tenant cloud infrastructure system is greater than the stress limit, the multi-tenant cloud infrastructure system is in stress.

At 712, the computing device can permit the first tenant access to the additional processing capacity to process a number of requests concurrently greater than the limited number of requests. In some embodiments, the computing device withdraws a token from a global bucket. The token represents a unit of processing capacity used to process the request. The computing device can further transmit the token to the first tenant.

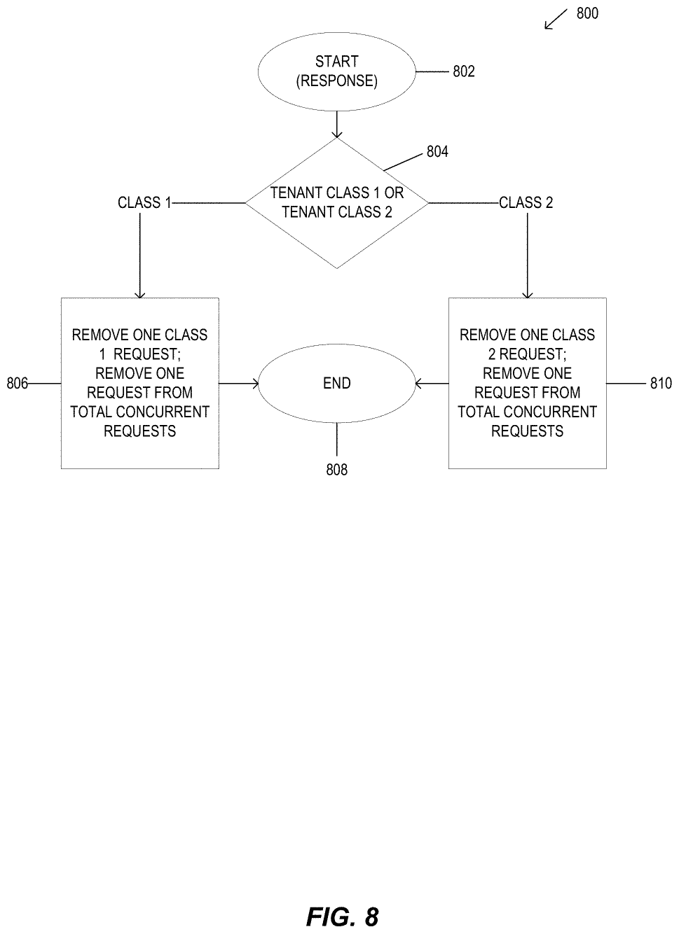

Referring to FIG. 8, an exemplary response phase flow chart 800 for according to an embodiment is shown. At 802, a computing device can initiate a response upon processing a request. At 804, the computing device can determine whether the response was directed to a class one tenant or a class two tenant. If the request was directed to a class one tenant, the computing device can remove one request from the number of requests attributed to the class one tenant, and remove one requests from the total number of requests in the multi-tenant cloud infrastructure system at 806. If the request was directed to a class two tenant, the computing device can remove one request from the number of requests attributed to the class two tenant, and remove one requests from the total number of requests in the multi-tenant cloud infrastructure system at 808. In either path, the process can end at 808.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing, and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may first need to be set up. In some instances, the provisioning can be done manually, a provisioning tool may be utilized to provision the resources, and/or deployment tools may be utilized to deploy the code once the infrastructure is provisioned.

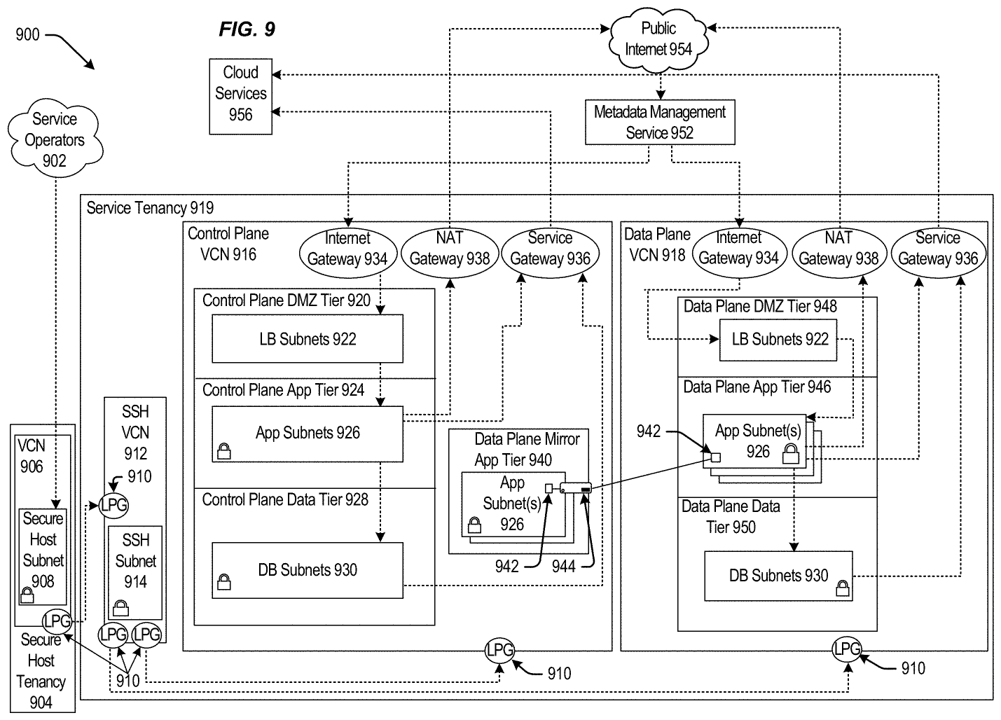

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 14, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively couple to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Memory that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

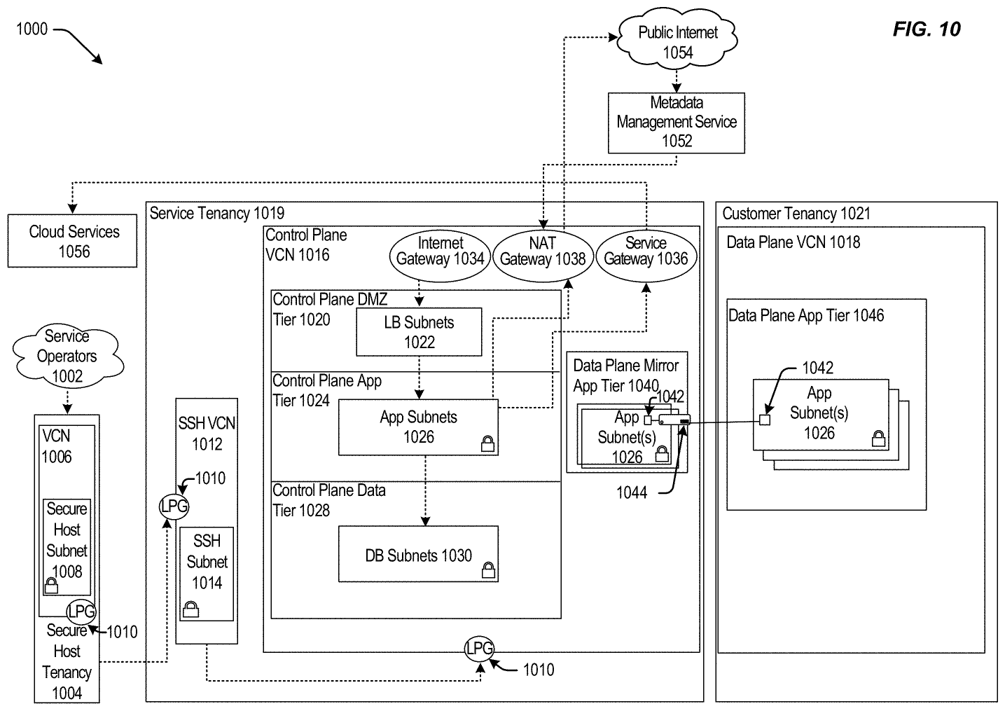

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1076 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 1010 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942 of FIG. 9) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 1046 of FIG. 10) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 902 of FIG. 9) that can be communicatively coupled to public Internet 1054 (e.g., public Internet 904 of FIG. 9). Public Internet 1054 can be communicatively coupled to the NAT gateway 1038 contained in the control plane VCN 1016. The service gateway 1036 contained in the control plane VCN 1016 can be communicatively couple to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 1,” may be located in Region 1 and in “Region 2.” If a call to Deployment 1 is made by the service gateway 1036 contained in the control plane VCN 1016 located in Region 1, the call may be transmitted to Deployment 1 in Region 1. In this example, the control plane VCN 1016, or Deployment 1 in Region 1, may not be communicatively coupled to, or otherwise in communication with, Deployment 2 in Region 2.

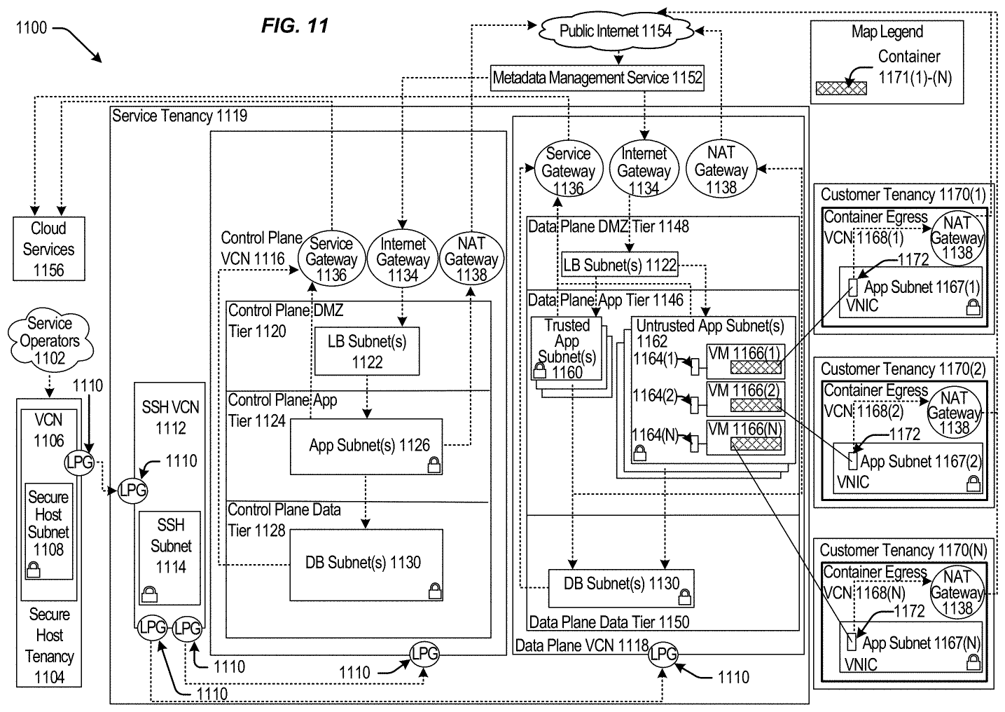

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 1106 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway 936 of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

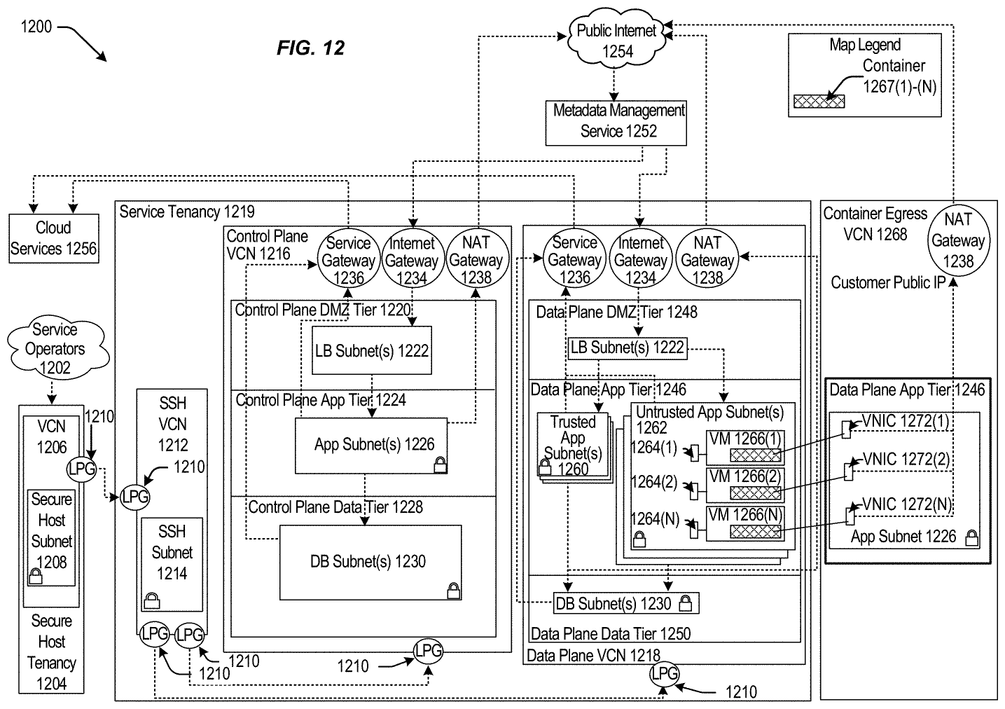

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 930 of FIG. 9). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway 936 of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively couple to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

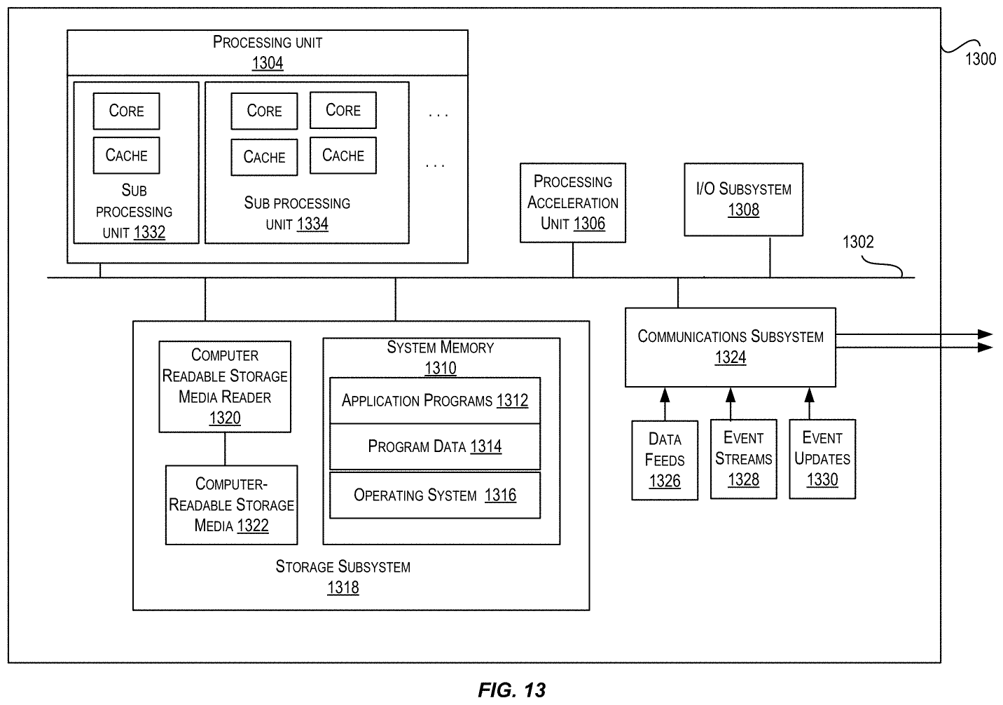

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that comprises software elements, shown as being currently located within a system memory 1310. System memory 1310 may store program instructions that are loadable and executable on processing unit 1304, as well as data generated during the execution of these programs.

Depending on the configuration and type of computer system 1300, system memory 1310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1304. In some implementations, system memory 1310 may include multiple different types of memory, such as static random access memory (SRAM) or dynamic random access memory (DRAM). In some implementations, a basic input/output system (BIOS), containing the basic routines that help to transfer information between elements within computer system 1300, such as during start-up, may typically be stored in the ROM. By way of example, and not limitation, system memory 1310 also illustrates application programs 1312, which may include client applications, Web browsers, mid-tier applications, relational database management systems (RDBMS), etc., program data 1314, and an operating system 1316. By way of example, operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1318 may also provide a tangible computer-readable storage medium for storing the basic programming and data constructs that provide the functionality of some embodiments. Software (programs, code modules, instructions) that when executed by a processor provide the functionality described above may be stored in storage subsystem 1318. These software modules or instructions may be executed by processing unit 1304. Storage subsystem 1318 may also provide a repository for storing data used in accordance with the present disclosure.

Storage subsystem 1300 may also include a computer-readable storage media reader 1320 that can further be connected to computer-readable storage media 1322. Together and, optionally, in combination with system memory 1310, computer-readable storage media 1322 may comprehensively represent remote, local, fixed, and/or removable storage devices plus storage media for temporarily and/or more permanently containing, storing, transmitting, and retrieving computer-readable information.

Computer-readable storage media 1322 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by computing system 1300.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem %524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 302.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, the method comprising:
receiving, by a computing device, a request directed to a first tenant of a multi-tenant cloud infrastructure system, the first tenant being granted access to a limited processing capacity to process a limited number of requests concurrently;
determining, by the computing device, whether to throttle the request, or permit the request and grant the first tenant access to additional processing capacity to process the request, the determination comprising:
determining a total number of requests to the first tenant and a second tenant in the multi-tenant cloud infrastructure system, the total number of requests to the first tenant and the second tenant in the multi-tenant cloud infrastructure system including the received request to the first tenant;
determining a stress limit of the multi-tenant cloud infrastructure system by applying a stress factor value to a maximum number of requests the multi-tenant cloud infrastructure system is capable of processing concurrently; and
comparing the determined total number of requests to the first tenant and the second tenant in the multi-tenant cloud infrastructure system against the determined the stress limit; and
permitting, by the computing device, the first tenant access to the additional processing capacity to concurrently process a number of requests greater than the limited number of requests.

2. The computer-implemented method of claim 1, further comprising authenticating the received request by an application programming interface gateway based at least in part on a set of credentials.

3. The computer-implemented method of claim 1, wherein the total number of requests in the multi-tenant cloud infrastructure system is less than the stress limit, wherein permitting the tenant access to the additional processing capacity to concurrently process the number of requests greater than the limited number of requests comprises retrieving a token from a global bucket, wherein the global bucket comprises a collection of tokens, and wherein each token of the global bucket comprises a unit of processing capacity shared by the first tenant and the second tenant of the multi-tenant cloud infrastructure system.

4. The computer-implemented method of claim 1, further comprising determining a class of the first tenant, wherein the multi-tenant cloud infrastructure system comprises a hierarchical class system, wherein the first tenant is associated with a first class and the second tenant is associated with a second class, wherein the first tenant is entitled to more processing capacity than the second tenant based at least in part on being associated with the first class, and wherein determining whether to allow or reject the first tenant access to additional processing capacity to process the request is based at least in part on the first tenant being associated with the first class.

5. The computer-implemented method of claim 1, wherein the request is received at a data plane of the multi-tenant cloud infrastructure system.

6. The computer-implemented method of claim 1, further comprising incrementing the total number of requests to the first tenant and a second tenant in the multi-tenant cloud infrastructure system by one in response to permitting the first tenant access to the additional processing capacity.

7. The computer-implemented method of claim 1, wherein the stress factor value is determined by a cloud services provider managing the multi-tenant cloud infrastructure system.

8. A computing system, comprising:
a processor; and
a computer-readable medium including instructions that, when executed by the processor, cause the processor to:
receive a request directed to a first tenant of a multi-tenant cloud infrastructure system, the first tenant being granted access to a limited processing capacity to process a limited number of requests concurrently;
determine whether to throttle the request, or permit the request and grant the first tenant access to additional processing capacity to process the request, the determination comprising:
determining a total number of requests to the first tenant and a second tenant in the multi-tenant cloud infrastructure system, the total number of requests to the first tenant and the second tenant in the multi-tenant cloud infrastructure system including the received request to the first tenant;
determining a stress limit of the multi-tenant cloud infrastructure system by applying a stress factor value to a maximum number of requests the multi-tenant cloud infrastructure system is capable of processing concurrently; and
comparing the determined total number of requests to the first tenant and the second tenant in the multi-tenant cloud infrastructure system against the determined the stress limit; and
permit the first tenant access to the additional processing capacity to concurrently process a number of requests greater than the limited number of requests.

9. The computing system of claim 8, wherein the processor further authenticates the received request by an application programming interface gateway based at least in part on a set of credentials.

10. The computing system of claim 8, wherein the total number of requests in the multi-tenant cloud infrastructure system is less than the stress limit, wherein permitting the tenant access to the additional processing capacity to concurrently process the number of requests greater than the limited number of requests comprises retrieving a token from a global bucket, wherein the global bucket comprises a collection of tokens, and wherein each token of the global bucket comprises a unit of processing capacity shared by the first tenant and the second tenant of the multi-tenant cloud infrastructure system.

11. The computing system of claim 8, wherein the processor further determines a class of the first tenant, wherein the multi-tenant cloud infrastructure system comprises a hierarchical class system, wherein the first tenant is associated with a first class and the second tenant is associated with a second class, wherein the first tenant is entitled to more processing capacity than the second tenant based at least in part on being associated with the first class, and wherein determining whether to allow or reject the first tenant access to additional processing capacity to process the request is based at least in part on the first tenant being associated with the first class.

12. The computing system of claim 8, wherein the request is received at a data plane of the multi-tenant cloud infrastructure system.

13. The computing system of claim 8, wherein the processor further increments the total number of requests to the first tenant and a second tenant in the multi-tenant cloud infrastructure system by one in response to permitting the first tenant access to the additional processing capacity.

14. The computing system of claim 8, wherein the stress factor value is determined by a cloud services provider managing the multi-tenant cloud infrastructure system.

15. A non-transitory computer-readable medium having stored thereon a sequence of instructions which, when executed by a processor, causes the processor to perform operations comprising:
receiving a request directed to a first tenant of a multi-tenant cloud infrastructure system, the first tenant being granted access to a limited processing capacity to process a limited number of requests concurrently;
determining whether to throttle the request, or permit the request and grant the first tenant access to additional processing capacity to process the request, the determination comprising:
determining a total number of requests to the first tenant and a second tenant in the multi-tenant cloud infrastructure system, the total number of requests to the first tenant and the second tenant in the multi-tenant cloud infrastructure system including the received request to the first tenant;
determining a stress limit of the multi-tenant cloud infrastructure system by applying a stress factor value to a maximum number of requests the multi-tenant cloud infrastructure system is capable of processing concurrently; and
comparing the determined total number of requests to the first tenant and the second tenant in the multi-tenant cloud infrastructure system against the determined the stress limit; and
permitting the first tenant access to the additional processing capacity to concurrently process a number of requests greater than the limited number of requests.

16. The non-transitory computer-readable medium of claim 15, wherein the operations further comprise authenticating the received request by an application programming interface gateway based at least in part on a set of credentials.

17. The non-transitory computer-readable medium of claim 15, wherein the total number of requests in the multi-tenant cloud infrastructure system is less than the stress limit, wherein permitting the tenant access to the additional processing capacity to concurrently process the number of requests greater than the limited number of requests comprises retrieving a token from a global bucket, wherein the global bucket comprises a collection of tokens, and wherein each token of the global bucket comprises a unit of processing capacity shared by the first tenant and the second tenant of the multi-tenant cloud infrastructure system.

18. The non-transitory computer-readable medium of claim 15, wherein the operations further comprise determining a class of the first tenant, wherein the multi-tenant cloud infrastructure system comprises a hierarchical class system, wherein the first tenant is associated with a first class and the second tenant is associated with a second class, wherein the first tenant is entitled to more processing capacity than the second tenant based at least in part on being associated with the first class, and wherein determining whether to allow or reject the first tenant access to additional processing capacity to process the request is based at least in part on the first tenant being associated with the first class.

19. The non-transitory computer-readable medium of claim 15, wherein the request is received at a data plane of the multi-tenant cloud infrastructure system.

20. The non-transitory computer-readable medium of claim 15, wherein the operations further comprise incrementing the total number of requests to the first tenant and a second tenant in the multi-tenant cloud infrastructure system by one in response to permitting the first tenant access to the additional processing capacity.
